(19) United States
(12) Patent Application Publication
(10) Pub. No.: US 2007/0223429 A1
(43) Pub. Date: Sep. 27, 2007

(54) Method and apparatus to facilitate use of cable television coaxial cable for local area network services

(75) Inventors: Ali Akgun, Seattle, WA (US); John G. Fijolek, Naperville, IL (US); Bill Huang, San Ramon, CA (US); Rick Flint, Zion, IL (US); Dawei Zhang, Saratoga, CA (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc., Alameda, CA (US)

(21) Appl. No.: 11/385,470

(22) Filed: Mar. 21, 2006

(51) Int. Cl. H04N 7/173; H04Q 7/24; H04L 12/56

(52) U.S. Cl. 370/338; 370/447; 725/131; 370/401

(57) ABSTRACT

A wireless local area network access point (200) has a data communication network input (201) (to provide, for example, broadband access via a digital subscriber line modem, a cable modem, or the like). The access point also has a wireless local area network output (202) to provide wireless access to this broadband resource and a hard-wired local area network output (203) to provide wired access. In a preferred approach the latter couples to a cable television coaxial cable (308) that carries a plurality of cable television service provider channels within a predetermined frequency band (304). Access to the broadband resource comprises use of a carrier (307) that is out of band with respect to that predetermined frequency band.

### TECHNICAL FIELD

This invention relates generally to local area networks and more particularly to wireless and hard-wired local area network support.

### BACKGROUND

In-home broadband networking comprises an important and growing area of endeavor. Interest and corresponding deployment has grown along with increased options and opportunities to send and/or receive various multimedia services (including voice and video services, streaming audio services, and so forth). Present broadband networking solutions include Ethernet (using Cat5 cabling), phone line or power line-based carriers, and numerous wireless technologies such as ultrawideband (UWB) and the 802.11 family of wireless local area network standards.

Typically, none of the above services are used in the first instance to provide broadband services within the home itself. Instead, broadband services usually arrive using a different wireless technology (such as a satellite-based technology or Motorola's Canopy technology) or a landline service such as cable television or digital subscriber lines. Almost without exception, these popular carrier techniques are not used within the home to support an in-home broadband local area network. Instead, modems and/or access points serve as translation points and gateways to operably couple the external broadband point of entry to an in-home local area network.

For example, a cable modem serves to extract an in-band data carrier from the cable television programming itself and to then provide Ethernet-based access thereto. In a typical scenario, a home owner then couples a wireless access point (such as an 802.11(g)-compatible wireless access point) via Ethernet to that cable modem to provide a wireless local area network at their home.

Wireless comprises a satisfactory solution for many purposes. There are circumstances, however, when a given home owner may wish for a hard-wired solution (often in addition to their wireless solution). Many present solutions require installation of a unique physical carrier such as Cat5 cabling to meet this need. This can be time consuming and expensive when employed with existing homes due to an aesthetic desire to hide such cabling within the walls, floors, and/or ceilings of the home. Other alternatives, such as phone line or power line-based solutions, present their own corresponding set of concerns and issues.

### BRIEF DESCRIPTION OF THE DRAWINGS

The above needs are at least partially met through provision of the method and apparatus to facilitate use of cable television coaxial cable for local area network services described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a block diagram as configured in accordance with various embodiments of the invention; and

FIG. 4 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, two-way data network service is provided to a location (such as, but not limited to, a residence). This two-way data network service can be provided via any available and appropriate means of conveyance as may be presently known or hereafter-developed, including but not limited to digital subscriber line, cable television, satellite transmission, and so forth. This process also presumes provision of cable television coaxial cable at this same location, which cable typically carries a plurality of cable television service provider channels within a predetermined frequency band (in accordance, for example, with existing prior art practice in this regard). In addition to providing wireless local area network access to the aforementioned two-way data network service at this location, one also provides wired local area network access to this two-way data network service (again, at this location) using this cable television coaxial cable.

In a preferred approach this comprises providing such local area network access using a carrier that is out of band with respect to the aforementioned predetermined frequency band as is used for the cable television service provider channels. For example, the local area network services can be provided using a carrier frequency (or frequencies) that is higher than the predetermined frequency band. Also in a preferred approach, an 802.11-family Medium Access Control (MAC) protocol is employed to bear the wired local access network signaling.

So configured, the cable television coaxial cable, which many homes already possess, serves both to support distribution of cable television programming within the home and also to support provision of two-way access to broadband data services. These teachings therefore permit significant leveraging of already-installed coaxial cable in many homes. This, in turn, can yield significant savings with respect to local area network start-up costs. These teachings are also respectful of resources and tend to preserve rather than challenge the aesthetic needs and desires of homeowners.

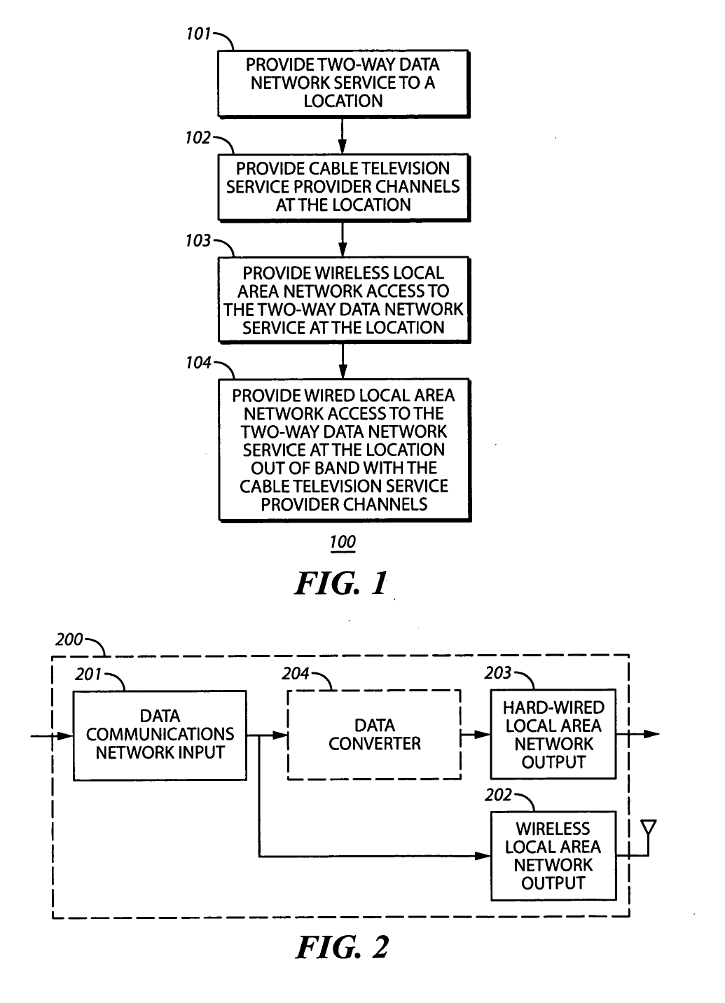

These and other benefits may become clearer upon making a thorough review and study of the following detailed description. Referring now to the drawings, and in particular to FIG. 1, an enabling process 100 will preferably comprise provision 101 of two-way data network service to a given location (such as a single family home, a multiple-family dwelling, a retail or commercial establishment, an industrial enterprise, and so forth). The two-way data network service itself can be provided using any presently known (or likely, any hereafter developed) approach. For example, digital subscriber line (DSL) services can be satisfactorily employed as can broadband satellite services. One may also provide such services using cable television coaxial cable wherein the two-way data network services are provided using at least one of the plurality of conveyed cable television service provider channels. Such approaches are well understood in the art and require no further elaboration here. In general, such two-way data network service preferably comprises broadband Internet access service.

This process 100 also preferably provides 102 cable television coaxial cable at this location, wherein this cable carries a plurality of cable television service provider channels within a predetermined frequency band. This, too, comprises a well-understand prior art technique and requires no further elaboration here. It may be appropriate or helpful to also provide filtering (for example, at the point of entry) for this coaxial cable to thereby at least substantially prevent other signaling (as will be described below) from propagating beyond the location.

This process 100 then provides both for provision 103 of wireless local area network access to the aforementioned two-way data network service at the location and for provision 104 of wired local area network access to the two-way data network service at this location using the cable television coaxial cable. In a preferred approach, the latter comprises providing the two-way data network service out of band with respect to the predetermined frequency band that carries ordinary cable television programming. For example, the two-way data network service can be provided using a higher carrier frequency than the predetermined frequency band. For example, by one approach the two-way data network service can be provided within a frequency band of about 550 Mhz to about 1 Ghz. In a preferred approach this two-way data network service is provided through use of an 802.11-family Medium Access Control (MAC) protocol (such as, but not limited to, 802.11(a), 802.11(b), and/or 802.11(g) protocols and standards as are known in the art).

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

The depicted apparatus comprises a wireless local area network access point 200 having a data communications network input 201 that operably couples to a broadband point of entry such as (but not limited to) a DSL modem, a cable modem, or the like. This wireless local area network access point 200 also comprises a wireless local area network output 202 that preferably (though not necessarily) supports a Medium Access Control (MAC) protocol as is presently known in the art. For many applications a MAC protocol such as an 802.11-family compatible protocol will likely serve well. This wireless local area network output 202 serves, in a typical deployment, as a wireless local area network access point for such wireless devices as the operator and/or system administrator may wish to attach.

This embodiment further preferably comprises a hard-wired local area network output 203 that also uses a MAC protocol. In a preferred embodiment this MAC protocol will be the same as that which is supported by the wireless local area network output 202, though these protocols can be different from one another if desired. In a preferred approach this hard-wired local area network output 203 is compatibly coupleable to a cable television coaxial cable (not shown) that carries a plurality of cable television service provider channels within a predetermined frequency band. More particularly, the hard-wired local area network output 203 supports a carrier that is above that predetermined frequency band and hence non-interfering therewith. In particular, insertion of the local area network content into the cable television coaxial cable will not interfere with reception of the cable television service provider channels by, for example, televisions, recorders, and so forth as are also coupled to that coaxial cable.

In many cases the hard-wired local area network output 203 will not have native compatibility with the data communication network input 201. In such as case a data converter 204 can be operably coupled there between. In a preferred approach this data converter 204 serves to convert data from the data communications network input 201 into MAC protocol data as is supported by the hard-wired local area network output 203 and that is borne by the carrier used thereby.

So configured, such a local area network access point can interface with a data extranet (such as the Internet). This access point can offer both wireless local area network access to that data extranet and can also support wired local area network access to that data extranet via cable television coaxial cable by use of one or more carriers that are out of band with respect to the programming channels carried by that coaxial cable.

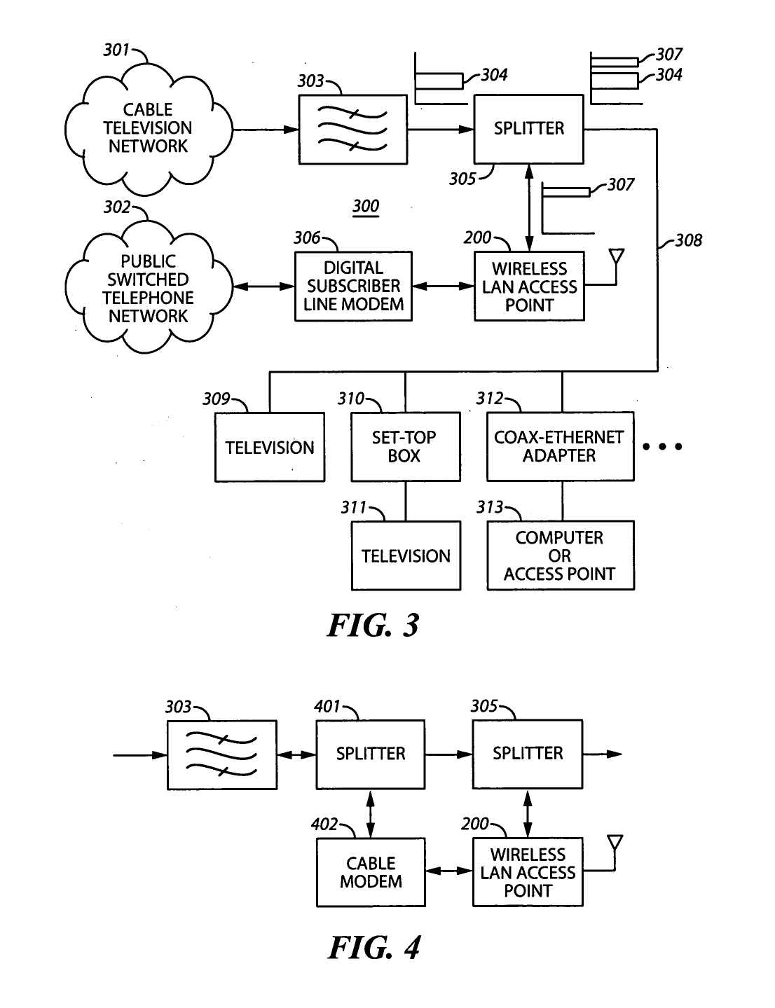

An illustrative deployment will now be described with respect to FIG. 3. In this illustrative embodiment a given location 300 couples both to a cable television network 301 and the public switched telephone network 302. In this embodiment a bandpass filter 303 is employed to prevent signaling described below from propagating back towards the cable television network 301. This bandpass filter 303 serves to pass a range of frequencies 304 that contain the ordinary cable television programming channels (which can include, though not in this embodiment, broadband Internet access carriers).

The public switched telephone network 302 couples to a DSL modem 306 as is known in the art. The latter serves to extract the broadband Internet carrier and content from the incoming telephone line. A wireless local area network access point 200 as is described above with respect to FIG. 2 receives this broadband content and provides wireless access thereto in accordance with known prior art technique. As described above, however, this access point 200 also provides an output comprising a two-way broadband carrier 307 at a frequency, in this embodiment, that exceeds the frequency range of the cable television programming.

A splitter 305 (as is known in the art and acting here, in part, as a combiner) receives both the cable television programming 304 and the broadband content 307 and provides them in combined form to a coaxial cable 308. Various end-user platforms then connect to the coaxial cable and make use of the cable television programming, the broadband access, or both.

For example, a television 309 can couple to the coaxial cable in ordinary fashion in order to receive corresponding cable programming 304. The television, in most cases, will not process or otherwise interact with the available broadband content 307. In another case, however, a so-called set top box 301 may connect to the coaxial cable to provide the cable programming 304 to a corresponding television 311 while also using the broadband access to effect replenishment of programming guide information from an Internet source. In yet another case, a coax-Ethernet adapter 312 can be employed to permit coupling a computer, access point, or other similar platform 313 to the coaxial cable to thereby permit two-way interaction with the broadband carrier 307. Those skilled in the art will understand that these examples serve an illustrative purpose only and do not comprise an exhaustive listing of all possible examples.

So configured, access to broadband service arriving via a telephone line is provided using traditional wireless techniques but also via the coaxial cable that a location owner might already have as an installed asset. These teachings do not interfere with the ordinary and usual use of that coaxial cable (i.e., the delivery of television programming) and instead represent a powerful leveraging of that resource.

As previously mentioned, these teachings are similarly applicable with other broadband delivery mechanisms. For example, and referring now to FIG. 4, a given location operator may receive their two-way data network service access via their cable service provider. In such a case, the broadband content carrier typically comprises quadrature amplitude modulated or quadrature phase shift keyed data that is borne within the ordinarily supported frequency band that carries the television programming channels. Therefore, this broadband content will successfully pass through the previously mentioned bandpass filter 303.

In this embodiment, however, another splitter 401 serves to divert the cable signal into a cable modem 402 (the latter being well understood in the art). The cable modem 402 recovers the broadband content and provides it to the wireless local area network access point 200. The latter then operates as before to provide that broadband content, using a relatively high carrier frequency as compared to the cable content frequency range, through a splitter 305 to again be joined with the ordinary cable content. In this case, the resultant coaxial content includes both the original broadband content that is in-band with the usual cable programming (and which is essentially ignored by other entities on the home coaxial cable local area network) and the broadband content that is offered out of band with the usual cable programming (and this is used by data-capable entities that become attached to the coaxial cable).

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. An apparatus comprising:
a wireless local area network access point comprising:
a data communications network input;
a wireless local area network output that uses a first Medium Access Control (MAC) protocol;
a hard-wired local area network output that uses a second MAC protocol and that is compatibly coupleable to a cable television coaxial cable that carries a plurality of cable television service provider channels within a predetermined frequency band, wherein the hard-wired local area network output comprises a carrier that is above the predetermined frequency band.

2. The apparatus of claim 1 wherein the data communications network input is compatibly coupleable to at least one of:
a DSL modem;
a cable modem.

3. The apparatus of claim 1 wherein the first MAC protocol comprises an 802.11-family compatible protocol.

4. The apparatus of claim 1 wherein the second MAC protocol comprises an 802.11-family compatible protocol.

5. The apparatus of claim 1 wherein the first MAC protocol is the same as the second MAC protocol.

6. The apparatus of claim 1 wherein the first MAC protocol is different from the second MAC protocol.

7. The apparatus of claim 1 and further comprising means operably coupled to the data communications network input and the hard-wired local area network output for converting data from the data communications network input into second MAC protocol data that is borne by a carrier that exceeds the predetermined frequency band, such that insertion of the second MAC protocol data into the cable television coaxial cable will not interfere with reception of the cable television service provider channels.

8. A method comprising the steps of:
providing two-way data network service to a location;
providing cable television coaxial cable that carries a plurality of cable television service provider channels within a predetermined frequency band at the location;
providing wireless local area network access to the two-way data network service at the location;
providing wired local area network access to the two-way data network service at the location on the cable television coaxial cable out of band with respect to the predetermined frequency band.

9. The method of claim 8 wherein providing two-way data network service to a location comprises providing the two-way data network service using the cable television coaxial cable and at least one of the plurality of cable television service provider channels.

10. The method of claim 8 wherein providing two-way data network service to a location comprises providing the two-way data network service using a DSL line.

11. The method of claim 8 wherein providing two-way data network service comprises providing Internet access service.

12. The method of claim 8 wherein providing wired local area network access to the two-way data network service at the location on the cable television coaxial cable out of band with respect to the predetermined frequency band comprises providing the wired local area network access at a higher carrier frequency than the predetermined frequency band.

13. The method of claim 12 wherein providing cable television coaxial cable that carries a plurality of cable television service provider channels within a predetermined frequency band at the location further comprises filtering the cable television coaxial cable to at least substantially prevent a signal as corresponds to the wired local area network access from propagating beyond the location.

14. The method of claim 12 wherein providing wired local area network access to the two-way data network service at the location on the cable television coaxial cable out of band with respect to the predetermined frequency band further comprises using a splitter to combine the cable television service provider channels and a signal as corresponds to the wired local area network access on the cable television coaxial cable at the location.

15. The method of claim 8 wherein providing wired local area network access to the two-way data network service at the location on the cable television coaxial cable out of band with respect to the predetermined frequency band further comprises using an 802.11-family Medium Access Control (MAC) protocol to provide the wired local area network access.

16. The method of claim 15 wherein the 802.11-family MAC protocol is compatible with at least one of 802.11(a), 802.11(b), and 802.11(g).

17. A local area network access point for use at a location having cable television coaxial cable that carries a plurality of cable television service provider channels within a predetermined frequency band, comprising:
interface means for interfacing with a data extranet;
first means operably coupled to the interface means for providing wireless local area network access to the data extranet;
second means operably coupled to the interface means for using the cable television coaxial cable to provide wired local area network access to the data extranet at the location using a carrier that is out of band with respect to the predetermined frequency band.

18. The local area access point of claim 17 wherein the second means uses an 802.11-family compatible Medium Access Control (MAC) protocol to provide the wired local area network access.

19. The local area access point of claim 18 wherein the data extranet comprises, at least in part, the Internet.
